(19) United States
(12) Patent Application Publication
(10) Pub. No.: US 2017/0091815 A1
(43) Pub. Date: Mar. 30, 2017

(54) RESTRICTING TARGETED ADVERTISING ACROSS MULTIPLE ENVIRONMENTS

(71) Applicant: Facebook, Inc., Menlo Park, CA (US)

(72) Inventors: Jacob Andrew Brill, San Francisco, CA (US); Gianluca Iannaccone, Oakland, CA (US); Sarah Rotman Epps, San Carlos, CA (US); David Townsend Martin, San Francisco, CA (US)

(21) Appl. No.: 14/868,136

(22) Filed: Sep. 28, 2015

(51) Int. Cl. G06Q 30/02

(52) U.S. Cl. CPC G06Q 30/0255; G06Q 30/0257

(57) ABSTRACT

A user makes a request to restrict targeted advertising through third party services accessed on a client device. A publishing system obtains information indicating that the user requested to restrict targeted advertising. The publishing system updates a profile associated with an account of the user to indicate that the user has requested to restrict targeted advertising. Based on the update to the profile, when the user communicates with the publishing system through the same or a different client device, the publishing system is restricted as to the information that can be collected and used for targeted advertising

### BACKGROUND

This invention generally relates to advertising, and in particular to restricting targeted advertising across multiple environments.

Targeted advertising (also referred to as interest-based advertising and online behavioral advertising) is when advertisements are delivered to a user based on predicted interests of the user. To predict the user's interests, information is collected about the user. The collected information may include, for example, the user's actions on websites and applications. When an opportunity arises to present an advertisement to the user, the collected information is used to select the advertisement to present to the user.

Different options have been developed to give users the opportunity to limit entities from collecting information regarding user actions for purposes of serving targeted advertisements. For example, Digital Advertising Alliance (DAA) provides a tool accessible through a web browser where a user can opt out from the tracking of user actions for targeted advertising. When the user opts out, a cookie is set on the user's browser to indicate that the user has opted out. Based on the cookie, participating entities are limited as to the information they can collect about the user's actions for the purposes of providing targeted advertisements. As another example, on certain mobile devices, the operating system allows a user to set a setting for opting out from the tracking of user actions for targeted advertising.

However, the current solutions are limited to specific environments. For example, when a user opts out through the DAA tool, the user is opting out only for that browser. If the user performs activities on another browser or computer, information on the user's activities will be collected. Similarly, if the user opts out through the operating system of a mobile device and performs activities on a different device (e.g., on a desktop computer or on another mobile device), information will be collected.

### SUMMARY

In one embodiment, through a client device a user can communicate with a publishing system to access content. For example, the publishing system may be a social networking system and the user may communicate with the social networking system to access social networking content, such as content shared by connections (e.g., friends from the social network). The publishing system may include advertisements with content provided to the user. In order to provide advertisements that will likely be of interest to the user, the publishing system collects information on activities performed by the user on the client device. The use of collected information to provide advertisements to a user is referred to as targeted advertising. Examples of information collected for targeted advertising may include information on websites accessed by the user through the client device and information on activities performed by the user on applications running on the client device.

Through third party services accessible on the client device the user may request to restrict targeted advertising (e.g., limit information that may be collected for purposes of serving targeted advertisements). In one embodiment, the user makes the request by accessing a third party tool through a web browser. Based on the request, the third party tool sets a cookie on the browser indicating that the user has requested to restrict targeted advertising. In other embodiments, the user makes the request by setting an operating system setting for restricting targeted advertising.

When the publishing system determines that a request has been made by the user through the client device to restrict targeted advertising, the publishing system updates a profile associated with an account of the user to indicate that the user has requested to restrict targeted advertising. Based on the update to the profile, if the user communicates with the publishing system through a different environment (e.g., using a different browser or client device), the publishing system will still be restricted as to the information that can be collected for targeted advertising. Hence, when the user requests to restrict targeted advertising through a third party service that is independent from the publishing system, the publishing system applies the user's request to different environments used by the user to communicate with the publishing system. The user thus gets the benefit of being able to apply a personal or people-based opt out of tracking for targeted advertising that is associated with him rather than being associated only with his client device or browser.

### BRIEF DESCRIPTION OF THE DRAWINGS

FIG. 1 is a block diagram of a content sharing environment, in accordance with an embodiment of the invention.

FIG. 2 is a block diagram of an architecture of a client device, in accordance with an embodiment of the invention.

FIG. 3 is a block diagram of architecture of a publishing system, in accordance with an embodiment of the invention.

FIG. 4 is a diagram illustrating operations performed by a first client device, the publishing system, and a second client device when restricting targeted advertising for a user, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

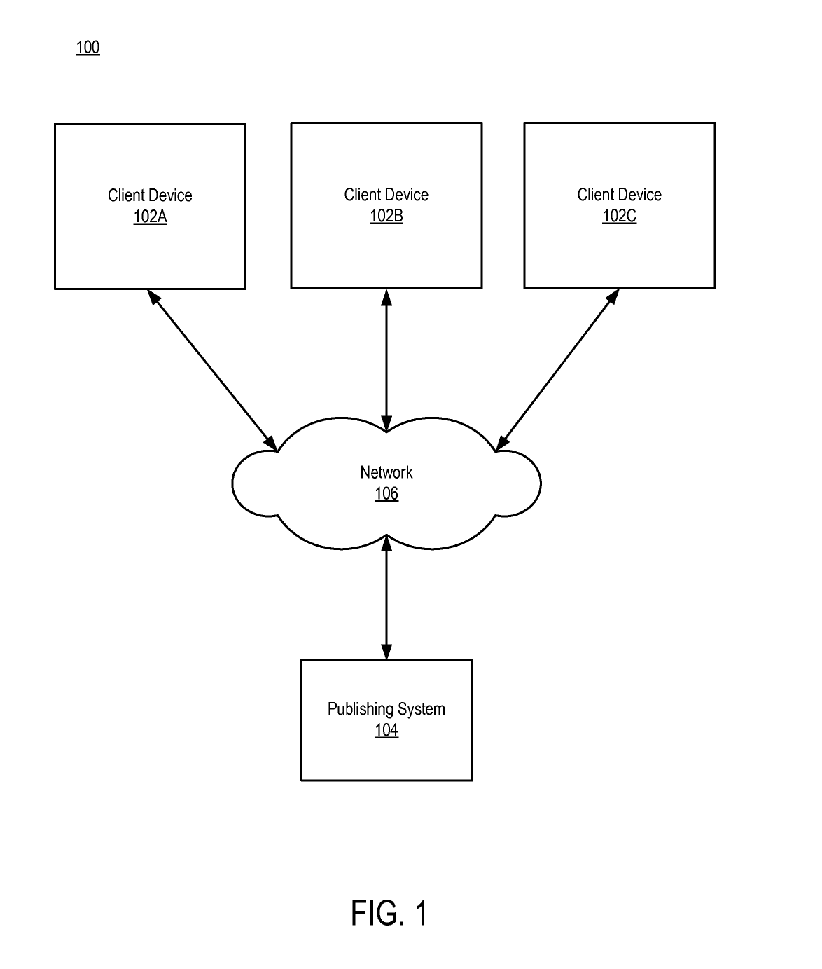

FIG. 1 is a block diagram of a content sharing environment 100, in accordance with an embodiment of the invention. The content sharing environment 100 shown by FIG. 1 includes client devices 102A, 102B, and 102C, a publishing system 104 and a network 106. Although a select number of each entity are shown in FIG. 1, embodiments can have more or less of each entity (e.g., additional client devices 102 and publishing systems 104).

FIG. 1 and the other figures use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g., 102A, 102B, and 102C).

A client device 102 is a computing device capable of receiving user inputs as well as sending and/or receiving data via the network 106. A client device 102 may be a mobile device, such as a mobile telephone, a tablet computer, or a personal digital assistant (PDA). Alternatively, a client device 102 may be a conventional computer system, such as a desktop computer.

Through a client device 102 a user may communicate with the publishing system 104 and request content. The content received from the publishing system 104 is displayed by the client device 102. The content may include one or more advertisements selected by the publishing system 104 for display with the content. In one embodiment, the advertisements are targeted advertisements selected based on information collected regarding actions performed by the user.

The user can also access a third party service through the client device 102 to request that targeted adverting to the user be restricted. The request may include, for example, that information regarding the user's activities on the client device 102 not be collected and used for purposes of providing the user with targeted advertisements (e.g., request to opt out of user actions being tracked for purposes of providing targeted advertisements). The third party service may be accessed, for example, through a web browser or settings of the client device 102. The third party service is independent from the publishing system 104 in that it not developed or run by the publishing system 104.

The publishing system 104 is a system that provides requested content to client devices 102. In one embodiment, the publishing system 104 is a social networking system that enables users of a social network to communicate and share content with each other. In one embodiment, the publishing system 104 maintains an account for each user of the publishing system 104. Each account is associated with a profile (may also be referred to as “user profile”) that includes information associated with the user of the account.

Information included in a user's profile is an indication as to whether the user has requested to restrict targeted advertising to the user. When the user logs into to their account with the publishing system 104 via a client device 102, if the user's profile indicates that the user has not requested to restrict targeted advertising, the publishing system 104 communicates with the client device 102 to determine whether the user has requested to restrict targeted advertising on the client device 102 (e.g. whether the user recently requested to restrict targeted advertising). In one embodiment, the publishing system 104 determines whether the user requested to restrict targeted advertising by determining whether a browser on the client device 102 includes an opt out cookie set by a third party service indicating that a request has been made on the client device 102 to restrict targeted advertising. In one embodiment, the publishing system 104 determines whether the user requested to restrict targeted advertising by obtaining settings information from the user's client device 102 (e.g., operating system settings information) and determining from the settings information whether a setting has been set on the client device 102 to restrict targeted advertising.

If the publishing system 104 determines that the user has not made a request on the client device 102 to restrict targeted advertising, the publishing system 104 periodically communicates with the client device 102 to determine whether the user has made a request since the last determination. On the other hand, if a determination is made that the user has requested on the client device 102 to restrict targeted advertising, the publishing system 104 updates the user's profile to indicate that the user requested to restrict targeted advertising. Based on the update to profile, tracking of the user's actions is modified. In one embodiment, based on the update to the profile, the publishing system 104 only tracks actions by the user with the publishing system 104, but not user actions with other systems (e.g., other publishing systems). In one embodiment, based on the update to profile, the publishing system 104 may not use certain tools that are typically available to track user actions, such as an identifier associated with the client device 102 or specific types of trackers.

When the user is logged into their account on the same client device 102 or via a different client device 102 and an opportunity arises to present an advertisement to the user, the publishing system 104 analyzes the user's profile and selects an advertisement to present to the user without violating the user's request to restrict targeted advertising. Hence, when the user requests to restrict targeted advertising on one client device 102 through a third party service, the publishing system 104 applies the user's request to that client device 102 and other client devices 102. The user only has to make the request once. The personalized or user-based opt out that is linked to the user himself rather than to his device allows the user to opt out across all devices.

The client devices 102 and the publishing system 104 are configured to communicate via the network 106, which may comprise any combination of local area and/or wide area networks, using both wired and/or wireless communication systems. In one embodiment, the network 106 uses standard communications technologies and/or protocols. For example, the network 106 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 106 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 106 may be represented using any suitable format, such as hypertext markup language (HTML) or extensible markup language (XML). In some embodiments, all or some of the communication links of the network 106 may be encrypted using any suitable technique or techniques.

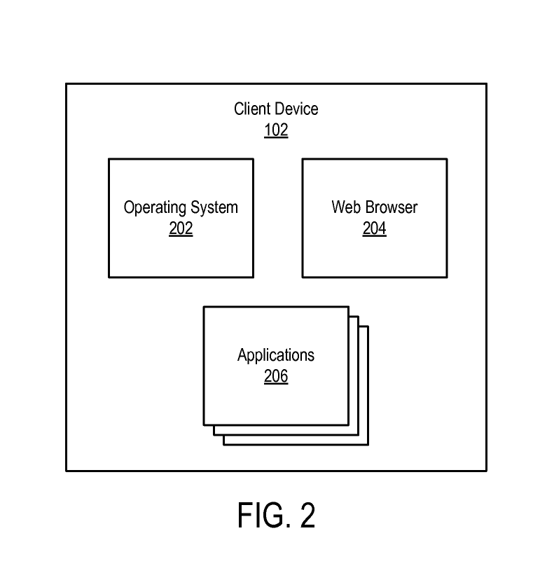

FIG. 2 is a block diagram of an architecture of a client device 102. The client device 102 shown in FIG. 2 includes an operating system 202, a web browser 204, and multiple applications 206. In other embodiments, the publishing system 104 may include additional, fewer, or different components for various applications.

The operating system 202 manages hardware and software resources of the client device 102. The operating system 202 provides applications 206 of the client device 102 with access to services through application program interfaces (APIs). Additionally, the operating system 202 provides user interfaces that allow users to interact with the client device 102.

In one embodiment, the operating system 202 stores an identifier associated with the client device 102. In one embodiment, the identifier is not permanent and can be changed. Entities that provide advertisements can associate activities performed by a user with the identifier and use information collected over time in association with the identifier to provide targeted advertisements to the user. In one embodiment, the operating system 202 allows users to activate a setting that restricts targeted advertising. In one embodiment, when a user activates the setting, a flag is set to indicate that entities are not allowed to use the identifier to collect information and serve targeted advertisements.

The web browser 204 allows users to access web pages provided by different publishing systems 104. At the request of the publishing system 104, the web browser 204 stores one or more cookies. A cookie is a file that stores information on activities performed by users through the web browser 204. For example, the cookie may store information on web pages accessed by a user and selections made by the user on different web pages. At the request of the publishing system 104, the web browser 204 sends the information stored by the cookie to the publishing system 104.

In one embodiment, through the web browser 204 a user can access a third party service that allows the user to request to restrict targeted advertising. In one embodiment, the third party service is provided by the Digital Advertising Alliance (DAA). In one embodiment, through the third party service, the user can request that all entities participating in the DAA or select entities be restricted from collecting information and using collected information for targeting advertisements to the user. When the user makes the request to restrict targeted advertising, the web browser 204 stores one or more opt out cookies that indicate which entities are restricted from collecting and using collected information to target advertisements to the user.

Each application 206 is a program that can be executed by the client device 102 to perform certain functions, tasks, or activities. In one embodiment, an application 206 is associated with the publishing system 104 and displays content provided by the publishing system 104 on the client device 102. For example, the application 206 may be a mobile application specifically developed for accessing content from the publishing system.

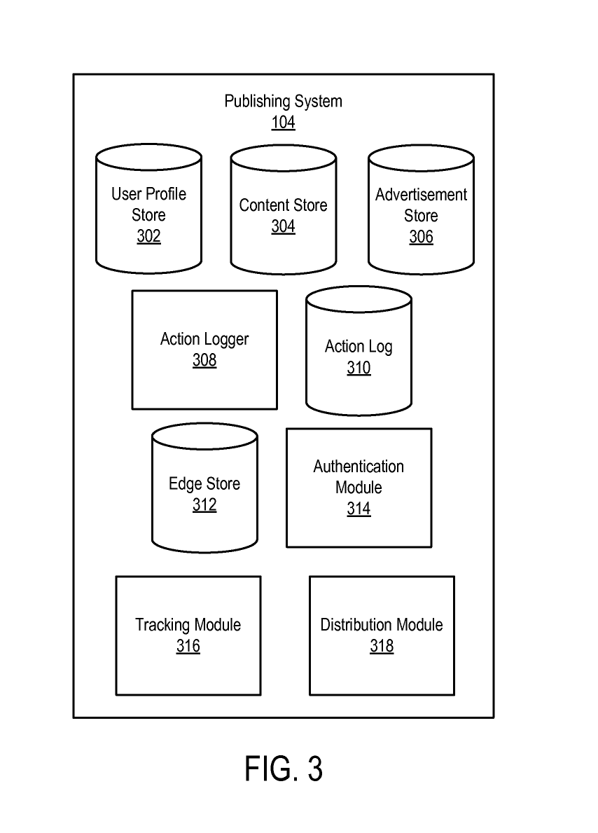

FIG. 3 is a block diagram of an architecture of the publishing system 104. In one embodiment, the publishing system 104 is a social networking system that allows users to join a social network, establish connections with users of the social network, and share content with users of the social network. The publishing system 104 shown in FIG. 3 includes a user profile store 302, a content store 304, an advertisement store 306, an action logger 308, an action log 310, an edge store 312, an authentication module 314, a tracking module 316, and a distribution module 318. In other embodiments, the publishing system 104 may include additional, fewer, or different components for various applications. Conventional components such as network interfaces, security functions, load balancers, failover servers, management and network operations consoles, and the like are not shown so as to not obscure the details of the system architecture.

Each user that has an account with the publishing system 104 is associated with a profile, which is stored in the user profile store 302. A user's profile includes declarative information about the user that was explicitly shared by the user and may also include profile information inferred by the publishing system 104. In one embodiment, a profile includes multiple data fields, each describing one or more attributes of the corresponding user of the publishing system 104. Examples of information stored in a user's profile include biographic, demographic, and other types of descriptive information, such as work experience, educational history, gender, hobbies or preferences, location and the like. A user's profile may also store other information provided by the user, for example, images or videos. In certain embodiments, images of users may be tagged with identification information of users of the publishing system 104 displayed in the images. A profile may also maintain references to actions by the corresponding user performed on content and stored in the action log 310.

Additionally, included in a user's profile is information indicating whether the user has requested to restrict targeted advertising through a client device 102. In one embodiment, if the user has made a general request to restrict targeted advertising, the profile will include a flag indicating that the user has requested to restrict targeted advertising. If the user has provided specific details on how to restrict targeted advertising, the profile will include a description of the specific restrictions desired by the user. For example, the profile may indicate that on specific client devices 102 information may not be collected regarding the user's actions on those client devices 102 and used for serving targeted advertisements. However, on other client devices 102, information may be collected for targeted advertising. As another example, the profile may indicate that information may be collected on actions performed by the user with the publishing system 104, but information cannot be collected on actions performed by the user with other systems.

The content store 304 stores objects that each represent various types of content. Examples of content represented by an object include a photograph, a video, an article, a link, a content item shared by a user, a post to a social networking page, an update to a social networking status (status update), a gaming application achievement by a user, an indication that the user is at a local business (a check-in event), a brand page for an entity, or any other type of content. In some embodiments, objects are received from third-party applications or third-party systems separate from the publishing system 104. Users of the publishing system 104 may also create objects stored by the content store 304 by providing content to the publishing system 104, such as links to content, status updates, photos, and information regarding an event. In one embodiment, objects in the content store 304 represent single pieces of content, or content “items.”

The advertisement store 306 stores advertisements provided by advertisers for inclusion with content provided to users. An advertisement may include, for example, one or more of the following: text, an image, audio, and a video. Stored with each advertisement are targeting criteria that describe characteristics of users to whom the advertisement should be presented. For example, the targeting criteria may indicate that the advertisement is to be presented to users with certain interests, that are male, and within a specific age range. The targeting criteria may indicate that the advertisement should be presented to a user only if the user performs a specific action or has a specific type of connection with another user or object. Additionally, the targeting criteria may indicate that the advertisement be presented with a certain type of content.

In one embodiment, stored with an advertisement are also a network address and a bid amount. The network address is the address of a page (e.g., a web page or a mobile application page) to which a user is directed when the user selects the advertisement. The bid amount is used to determine an expected value, such as monetary compensation, provided by an advertiser to the publishing system 104 if the advertisement is presented to a user, if the advertisement receives a user interaction, or based on any other suitable condition. For example, the bid amount may specify a monetary amount that the publishing system 104 receives from the advertiser if the advertisement is displayed and the expected value is determined by multiplying the bid amount by a probability of the advertisement being accessed by a user.

The action logger 308 receives information about user actions internal and/or external to the publishing system 104. Based on the received information, the action logger 308 populates the action log 310 with a description of the user actions. Examples of user actions include a user accessing certain content, establishing a connection with another user, sending a message to another user, uploading an image, reading a message, and responding to whether the user will attend an event, among others.

The action log 310 tracks user actions with the publishing system 104 and content provided by the publishing system 104, as well as actions with other systems (e.g., other publishing systems). Users may interact with various objects of the publishing system 104, and information describing these interactions are stored in the action log 310. Examples of interactions with objects include: accessing content, interacting with content, commenting on posts by users of the social network, sharing links to content, users indicating that they are at certain physical locations (e.g., checking-in to physical locations via a mobile device), and any other interactions. Additional examples of interactions with objects of the publishing system 104 that are included in the action log 310 include: commenting on a media item (e.g., a photo or video), communicating with a user, establishing a connection with an object, adding an event to a calendar, joining a group, creating an event, using an application, expressing a preference for an object (e.g., “liking” the object) and engaging in a transaction. Additionally, the action log 310 may record a user's interactions with advertisements provided by the publishing system 104. In some embodiments, data from the action log 310 is used to infer interests or preferences of a user, augmenting the interests included in the user's profile and allowing a more complete understanding of the user's preferences.

The action log 310 may also store user actions with third party systems. A third party system is a system that is separate from the publishing system 104, such as other publishing systems. Information regarding a user's actions with a third party system may be communicated to the publishing system 104 by the third party system or by the client device 102 used by the user the user to perform the actions. Examples of user actions with third party systems include accessing content, engaging/selecting advertisements, and purchasing goods and services.

The edge store 312 stores information describing connections between users and other objects of the publishing system 104 as edges. Some edges may be defined by users, allowing users to specify their relationships with other users. For example, users may generate edges with other users that parallel the users' real-life relationships, such as friends, co-workers, partners, and so forth. Other edges are generated when users interact with objects of the publishing system 104, such as expressing interest in content of the publishing system 104, sharing a link with other users of the publishing system 104, and commenting on posts made by other users of the publishing system 104.

In one embodiment, an edge may include various features each representing characteristics of interactions between users, interactions between users and objects, or interactions between objects. For example, features included in an edge may describe a rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into his account with the publishing system 104, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 312 also stores information about edges, such as affinity scores for objects, interests, and other users. Affinity scores, or “affinities,” may be computed by the publishing system 104 over time to approximate a user's affinity for an object, interest, and other users of the publishing system 104 based on the actions performed by the user. Computation of affinity is further described in U.S. patent application Ser. No. 12/978,265, filed on Dec. 23, 2010, U.S. patent application Ser. No. 13/689,969, filed on Nov. 30, 2012, U.S. patent application Ser. No. 13/690,088, filed on Nov. 30, 2012, and U.S. Pat. No. 9,070,141, filed on Nov. 30, 2012 each of which is hereby incorporated by reference in its entirety. Multiple interactions between a user and a specific object may be stored as a single edge in the edge store 312, in one embodiment. Alternatively, each interaction between a user and a specific object is stored as a separate edge. In some embodiments, connections between users may be stored in the user profile store 302, or the user profile store 302 may access the edge store 312 to determine connections between users.

The authentication module 314 authenticates users having accounts with the publishing system 104. In one embodiment, the authentication module 314 maintains authentication information for each user that has created an account with the publishing system 104 (e.g., signed up with the publishing system 104). In one embodiment, the authentication information includes a username (e.g., an email address) and a password.

In one embodiment, when a client device 102 communicates with the publishing system 104 to access certain content or perform certain actions, the authentication module 314 authenticates the user of the client device 102 to verify that the user has an account with the publishing system 104. In one embodiment, to authenticate a user, the authentication module 314 checks whether the user's device 102 includes a cookie with the user's authentication information. If the client device 102 includes a cookie with authentication information, the authentication module 314 verifies that the authentication information included in the cookie matches the authentication information stored by the authentication module 314 for the user. If the client device 102 does not includes a cookie, the authentication module 314 sends to the client device 102 instructions to present an interface through which the user can provide his authentication information. When the user provides authentication information via the interface, the authentication module 314 verifies the authentication information. In other embodiments, other methods may be used to authenticate the user, such as the client device 102 providing an authentication token. Once the user has been authenticated, the user is logged into his account.

The tracking module 316 manages the tracking of user actions. In one embodiment, the tracking module 316 provides to client devices 102 trackers that track user actions for purposes of providing targeted advertisements. The trackers may track user actions with the publishing system 104 and with third party systems. The trackers may be, for example, cookies and web beacons.

A cookie provided by the tracking module 316 to a user's client device 102 tracks action performed by the user through the client device 102. For example, a cookie stored by the client device's web browser 204 will track user actions through the web browser 204. When the client device 102 communicates with the publishing system 104, the tracking module 316 requests and receives from the client device 102 information stored by the cookie describing actions performed through the client device 102. The action logger 308 updates the action log 310 based on the received information.

In one embodiment, the tracking module 316 includes web beacons with the certain content provided to client devices 102. When the content is displayed by a client device 102, the web beacon provides information to the publishing system 104, such as the IP address of the client device 102, the time the content was displayed, and the web browser 204 used to display the content.

When a user communicates with the publishing system 104 through a client device 102 and the user is logged into his account with the publishing system 104, the tracking module 316 identifies the user's profile from the user profile store 302. The tracking module 316 determines whether the user's profile indicates that the user has requested to restrict targeted advertising. If the user's profile indicates that the user has not requested to restrict targeted advertising, the tracking module 316 communicates with the client device 102 to determine whether the user has requested to restrict targeted advertising on the client device 102 through a third party service.

In one embodiment, the tracking module 316 determines whether the user has requested to restrict targeted advertising on the client device 102 by obtaining information from the client device 102 as to whether an opt out cookie has been set indicating a request to restrict targeted advertising or whether an operating system setting of the client device 102 has been set for restricting targeted advertising. If information obtained by the tracking module 316 from client device 102 indicates that an opt out cookie has been set by a third party service, the tracking module 316 determines that the user has requested on the client device 102 to restrict targeted advertising. Additionally, the tracking module 316 determines that the user has requested to restrict targeted advertising if the obtained information indicates that an operating system setting has been set on the client device 102 for restricting targeted advertising.

If a determination is made that the user has requested to restrict targeted advertising through the client device 102, the tracking module 316 updates the user's profile to indicate that the user has requested to restrict targeted advertising. In one embodiment, tracking module 316 updates the tracking of the user in view of the update to the user's profile. The tracking module 316 updates the tracking of the user on that client device 102 and other client devices 102 used by the user to communicate with the publishing 104. In one embodiment, in view of the update to the profile, the tracking module 316 stops using certain tools to track the user's action. For example, the tracking module 316 may not use identifiers associated with client devices 102 to track user actions. In one embodiment, in view of the update to the profile, the tracking module 316 continues using trackers to track user actions with the publishing system 104 and its content, but stops using trackers to track user actions with other systems.

In one embodiment, as part of updating the tracking of the user, the tracking module 316 sets an opt out cookie on each web browser 204 of the client device 102 that does not already include an opt out cookie. Additionally, the tracking module 316 determines whether the operating system 202 of the client device 102 includes a setting to restrict targeted advertising. If the operating system 202 of the client device 102 includes the setting and the setting is not set to restrict targeted advertising, the tracking module 316 instructs the client device 102 to set the setting to restrict targeted advertising. Additionally, each time the user communicates with the publishing system 104 via a different client device 102, the tracking module 316 verifies that each web browser 204 of the client device 102 includes an opt out cookie and that any setting to restrict targeted advertising is set. These actions by the tracking module 316 insure that not only will the publishing system 104 be restricted as to what information is collected and used for targeted advertising, but other systems will also be restricted because the opt out cookies and the settings will make the other systems aware that the user has requested to restrict targeted advertising.

Further, the tracking module 316 allows the user to customize his or her profile regarding restrictions on targeted advertising. If the user requests to customize the restrictions on targeted advertising, the tracking module 316 provides a user interface to the client device 102 to allow the user to customize the restrictions on targeted advertising. Through the user interface the user may indicate one or more of the following: specific client devices 102 from which information may be collected for targeted advertising, specific actions that can or cannot be tracked and specific systems with which actions can or cannot be tracked. Additionally, through the user interface, the user may remove restrictions on targeted advertising previously set. Based on the information provided in the user interface, the tracking module 316 updates the user's profile to indicate the user's restrictions on targeted advertising. Additionally, the tracking module 316 updates the tracking of the user in view of the update to the user's profile. For example, if the user indicated that actions can be tracked on a first client device 102 but not a second client device 102, the tracking module 316 will leave trackers on the first client device 102 but will remove trackers from the second client device 102.

The distribution module 318 provides requested content to client devices 102. When the publishing system 104 receives a request for content from a user through a client device 102, the distribution module 318 identifies the content. In some embodiments, the content is stored by the content store 304 and the distribution module 318 retrieves the requested content from the content store 304. In other embodiments, the distribution module 318 generates the requested content by organizing together multiple objects stored by the content store 304.

The distribution module 318 determines whether to include one or more advertisements with the content. In one embodiment, the distribution module 318 determines to include an advertisement with the content if the content includes one or more advertisement slots. In another embodiment, the distribution module 318 determines to include an advertisement if the requested content is of a type that a system administrator has indicated should include an advertisement.

If a determination is made to include one or more advertisements, the distribution module 318 selects candidate advertisements from advertisements stored by the advertisement store 306. The distribution module 318 selects as candidate advertisements, advertisements from the advertisements store 306 whose targeting criteria are satisfied by information associated with the user. The distribution module 318 selects the candidate advertisements using information of the user that is acceptable according to any restrictions for targeted advertising included in the user's profile (i.e., the candidate advertisements are selected without violating the user's restrictions on targeted advertising). In one embodiment, the user information used by the distribution module 318 includes information included in the user's profile (e.g., information explicitly shared by the user for inclusion in the profile) and actions included in the action log 310 that are associated with the user and collected by the tracking module 316 without violating any restrictions of the user.

From the candidate advertisements, the distribution module 318 selects advertisements to include with the content. In one embodiment, the distribution module 318 uses an auction process to select which advertisements to include with the content. In one embodiment, the auction process includes, for each candidate advertisement, the distribution module 318 calculating an expected value based on a bid amount associated with the candidate advertisement. The distribution module 318 selects a certain number of candidate advertisements having the highest expected values. The distribution module 318 sends the content along with the selected advertisements to the client device 102 for display to the user.

### Process

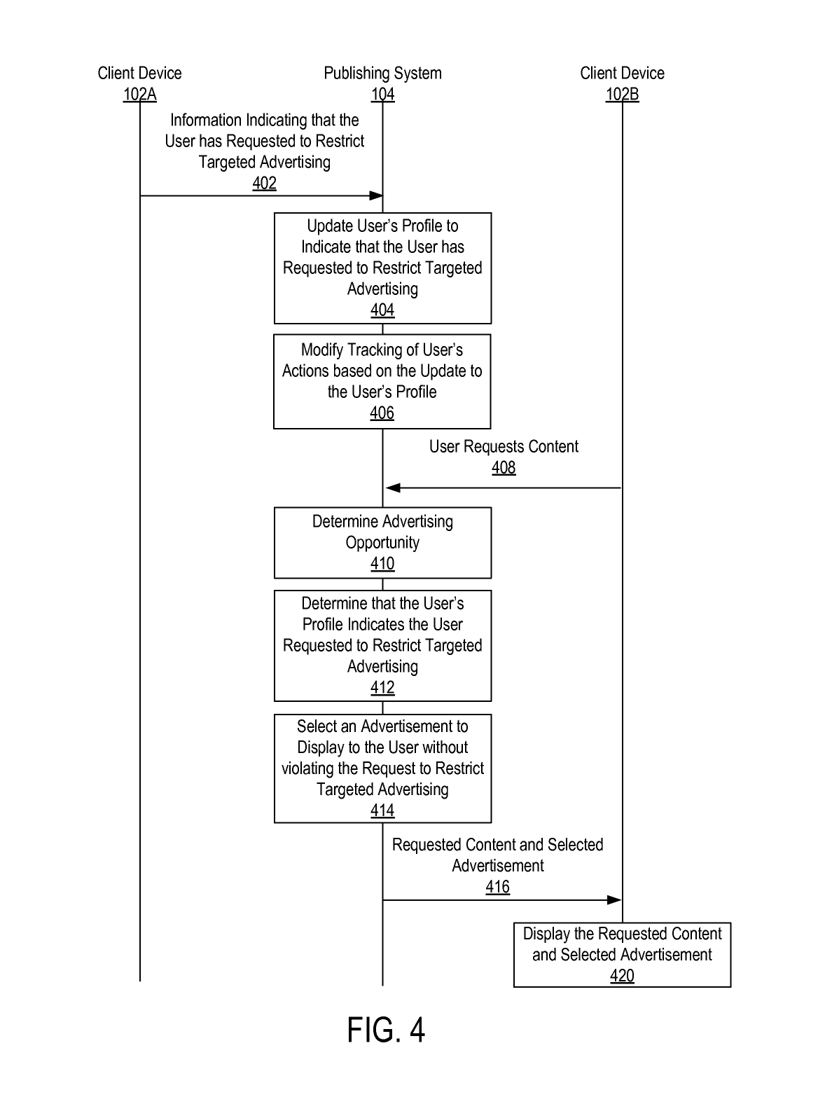

FIG. 4 is a diagram illustrating operations performed by a client device 102A, the publishing system 104, and a client device 102B when restricting targeted advertising for a user. Those of skill in the art will recognize that other embodiments can perform the steps of FIG. 4 in different orders. Moreover, other embodiments can include different and/or additional steps than the ones described herein.

Assume for purposes of this example, that the user is operating the client device 102A and is logged into an account with the publishing system 104. Additionally, assume that before or after logging into the account the user makes a request on the client device 102A through a third party service to restrict targeted advertising.

The publishing system 104 obtains 402 information from the client device 102A indicating that the user has requested on the client device 102A to restrict targeted advertising. For example, the information may indicate that an opt out cookie has been set by a third party service or that an operating system setting to restrict targeted advertising has been set on the client device 102A.

Based on the information, the publishing system 104 updates 404 the user's profile to indicate that the user has requested to restrict targeted advertising. The publishing system 104 also modifies 406 the tracking of the user's actions based on the update to the user's profile. For example, the publishing system 104 may send a request to the client device 102A that one or more trackers stored on the client device 102A be deleted.

Now assume that the user is operating client device 102B instead of client device 102A and has logged into his account with the publishing system 104 through client device 102B. For example, client device 102A may be a home desktop computer and the user made the request to restrict targeted advertising on the desktop computer. However, later in the day the user is operating client device 102B, which is a mobile device.

The user requests 408 content from the publishing system 104 through client device 102B. The publishing system 104 determines 410 that there is an opportunity to include an advertisement with the requested content. The publishing system 104 determines 412 that the user's profile indicates that the user requested to restrict targeted advertising. The publishing system selects 414 an advertisement to display to the user without violating the user's request to restrict targeted advertising.

The publishing system 104 sends 416 the requested content and the selected advertisement to the client device 102B. The client device 102B displays 420 the requested content and the selected advertisement.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a publishing system from a first client device associated with a user, information indicating a request by the user to restrict targeted advertising, the request made on the first client device through a third party service;
updating, by the publishing system, a user profile associated with the user to indicate that the user requested to restrict targeted advertising to the user;
receiving, by the publishing system from a second client device associated with the user, a request by the user for content, wherein the second client device is not set to restrict targeted advertising to the user;
responsive to receiving the request, determining, by the publishing system based on the user profile, that the user has requested to restrict targeted advertising to the user;
selecting an advertisement to provide to the second client device without violating the request to restrict targeted advertising to the user; and
sending, by the publishing system, the selected advertisement for display on the second client device.

2. The method of claim 1, wherein the information received from the first client device indicates that an opt out cookie was set on the first client by the third party service, the opt out cookie indicating a request to restrict targeted advertising was made on the first client device.

3. The method of claim 1, wherein the information received from the first client device indicates that an operating system setting to restrict targeted advertising was set on the first client device.

4. The method of claim 1, wherein the user has an account with the publishing system and the user is logged into the account through the first client device when the publishing system receives the information and the user is logged into the account through the second client device when the publishing system selects the advertisement.

5. The method of claim 1, further comprising:
limiting the use of tools to track actions of the user on the first client device and the second client device based on the user profile indicating that the user requested to restrict targeted advertising.

6. The method of claim 1, further comprising:
tracking user actions with the publishing system but not tracking user actions with additional systems based on the user profile indicating that the user requested to restrict targeted advertising.

7. The method of claim 1, further comprising:
instructing the second client device, based on the user profile indicating that the user requested to restrict targeted advertising, to set an opt out cookie that indicates to additional systems to restrict targeted advertising on the second client device.

8. The method of claim 1, further comprising:
instructing the second client device, based on the user profile indicating that the user requested to restrict targeted advertising, to set an operating system setting that indicates to additional systems to restrict targeted advertising on the second client device.

9. The method of claim 1, further comprising:
receiving a request from the user to update the user profile; and
updating the user profile to indicate one or more of the following: client devices from which information can be collected for targeted advertising, client devices from which information cannot be collected for targeted advertising, user actions that can be tracked for targeted advertising, and user actions that cannot be tracked for targeted advertising.

10. The method of claim 1, wherein selecting the advertisement comprises:
identifying information associated with the user obtained without violating the request to restrict targeted advertising; and
selecting the advertisement from a plurality of advertisements using the identified information.

11. A computer program product comprising a computer-readable storage medium containing computer program code for:
receiving, by a publishing system from a first client device associated with a user, information indicating a request by the user to restrict targeted advertising, the request made on the first client device through a third party service;
updating, by the publishing system, a user profile associated with the user to indicate that the user requested to restrict targeted advertising to the user;
receiving, by the publishing system from a second client device associated with the user, a request by the user for content, wherein the second client device is not set to restrict targeted advertising to the user;
responsive to receiving the request, determining, by the publishing system based on the user profile, that the user has requested to restrict targeted advertising to the user;
selecting an advertisement to provide to the second client device without violating the request to restrict targeted advertising to the user; and
sending, by the publishing system, the selected advertisement for display on the second client device.

12. The computer program product of claim 11, wherein the information received from the first client device indicates that an opt out cookie was set on the first client by the third party service, the opt out cookie indicating a request to restrict targeted advertising was made on the first client device.

13. The computer program product of claim 11, wherein the information received from the first client device indicates that an operating system setting to restrict targeted advertising was set on the first client device.

14. The computer program product of claim 11, wherein the user has an account with the publishing system and the user is logged into the account through the first client device when the publishing system receives the information and the user is logged into the account through the second client device when the publishing system selects the advertisement.

15. The computer program product of claim 11, wherein the computer program code is further for:
limiting the use of tools to track actions of the user on the first client device and the second client device based on the user profile indicating that the user requested to restrict targeted advertising.

16. The computer program product of claim 11, wherein the computer program code is further for:
tracking user actions with the publishing system but not tracking user actions with additional systems based on the user profile indicating that the user requested to restrict targeted advertising.

17. The computer program product of claim 11, wherein the computer program code is further for:
instructing the second client device, based on the user profile indicating that the user requested to restrict targeted advertising, to set an opt out cookie that indicates to additional systems to restrict targeted advertising on the second client device.

18. The computer program product of claim 11, wherein the computer program code is further for:
instructing the second client device, based on the user profile indicating that the user requested to restrict targeted advertising, to set an operating system setting that indicates to additional systems to restrict targeted advertising on the second client device.

19. The computer program product of claim 11, wherein the computer program code is further for:
receiving a request from the user to update the user profile; and
updating the user profile to indicate one or more of the following: client devices from which information can be collected for targeted advertising, client devices from which information cannot be collected for targeted advertising, user actions that can be tracked for targeted advertising, and user actions that cannot be tracked for targeted advertising.

20. The computer program product of claim 11, wherein selecting the advertisement comprises:
identifying information associated with the user obtained without violating the request to restrict targeted advertising; and
selecting the advertisement from a plurality of advertisements using the identified information.
